(19) United States
(12) Patent Application Publication
(10) Pub. No.: US 2012/0007530 A1
(43) Pub. Date: Jan. 12, 2012

(54) NOISE REDUCTION ARRANGEMENT RELATED TO A THREE-PHASE BRUSHLESS MOTOR

(75) Inventors: Takashi Imai, Okazaki-shi (JP); Takayuki Naito, Okazaki-shi (JP); Koichi Mizutani, Toyota-shi (JP); Kouichi Yamanoue, Hiroshima-shi (JP); Shigeki Yamamoto, Hiroshima-shi (JP)

(73) Assignees: Visteon Global Technologies, Inc., Van Buren Township, MI (US); Toyota Jidosha Kabushiki Kaisha, Toyota-shi, Aichi (JP)

(21) Appl. No.: 13/257,717

(22) PCT Filed: Mar. 17, 2010
(86) PCT No.: PCT/JP2010/055155

§ 371 Date: Sep. 20, 2011

(30) Foreign Application Priority Data
Apr. 1, 2009 (JP) 2009-089599

(51) Int. Cl. H02P 6/14

(52) U.S. Cl. 318/400.25

(57) ABSTRACT

An object of the present invention is to effectively reduce noise generated when driving a three-phase brushless motor. A noise reduction arrangement applied to a three-phase brushless motor is disclosed, wherein respective current loops, which are generated when two switching elements Q1 and Q2 related to U-phase are turned on or off in reversed phase with respect to each other, are opposed to each other in a direction of the normal to a board; respective current loops, which are generated when two switching elements Q3 and Q4 related to V-phase are turned on or off in reversed phase with respect to each other, are opposed to each other in a direction of the normal to the board; and respective current loops, which are generated when two switching elements Q5 and Q6 related to W-phase are turned on or off in reversed phase with respect to each other, are opposed to each other in a direction of the normal to the board.

### TECHNICAL FIELD

The present invention relates to a noise reduction arrangement related to a three-phase brushless motor and a motor drive system for a vehicle using the same.

### BACKGROUND ART

A three-phase brushless motor itself is well-known. For example, JP2003-235240 discloses it. In this type of three-phase brushless motor, a capacitor is connected between a positive power line and a negative power line of a direct-current power source, and three groups of two power MOS transistors in series are connected, respectively, between the positive power line and the negative power line. Star-connected inductive loads are connected to midpoints between transistors in the respective groups.

However, in a circuit configuration of the three-phase brushless motor disclosed in JP2003-235240, the respective current loops, which are generated when two switching elements related to U-phase, for example, are turned on or off in reversed phase with respect to each other, are generated in separate areas in a plane. As a result of this, magnetic fields in opposite directions are generated by the respective current loops alternately at a high-speed (i.e., for a short period). Thus, there is a problem that noise is generated due to such a variation in the magnetic field.

### DISCLOSURE OF INVENTION

Therefore, it is an object of the present invention to provide a noise reduction arrangement applied to a three-phase brushless motor by means of which noise generated when driving the three-phase brushless motor can be effectively reduced. Another object of the present invention is to provide a motor drive system for a vehicle.

In order to achieve the aforementioned objects, according to the first aspect of the present invention a noise reduction arrangement applied to a three-phase brushless motor is provided in which

respective current loops, which are generated when two switching elements related to U-phase are turned on or off in reversed phase with respect to each other, are opposed to each other in a direction of the normal to a board,

respective current loops, which are generated when two switching elements related to V-phase are turned on or off in reversed phase with respect to each other, are opposed to each other in the direction of the normal to the board, and

respective current loops, which are generated when two switching elements related to W-phase are turned on or off in reversed phase with respect to each other, are opposed to each other in the direction of the normal to the board.

According to the present invention, a noise reduction arrangement applied to a three-phase brushless motor is obtained which can effectively reduce noise generated when driving the three-phase brushless motor. Further, according to the present invention, a motor drive system for a vehicle using the noise reduction arrangement is obtained.

### BRIEF DESCRIPTION OF THE DRAWINGS

These and other objects, features, and advantages of the present invention will become more apparent from the following detailed description of preferred embodiments given with reference to the accompanying drawings, in which:

FIG. 1 is a diagram for illustrating an overview of an example of a motor drive system 1 for an electric vehicle;

FIG. 2 is a diagram for conceptually illustrating a circuit arrangement of an inverter 30 and a motor 40 for driving a vehicle in the motor drive system 1 shown in FIG. 1 to which an embodiment of a noise reduction arrangement according to the present invention is applied;

FIG. 3 is a timing chart of waveshapes of current and magnetic flux and shows an operation of the inverter 30 shown in FIG. 2;

FIG. 4 is a diagram for conceptually illustrating a circuit arrangement according to prior art;

FIGS. 5A-5C are diagrams for schematically illustrating flow of current in several conditions;

FIG. 6 is a diagram for conceptually illustrating a higher harmonics reduction effect according to the present embodiment; and

FIG. 7 is a diagram for conceptually illustrating a mounted status of the inverter shown in FIG. 2.

### EXPLANATION FOR REFERENCE NUMBER

1 motor drive system
2 battery
20 DC-DC converter
30 inverter
40 motor
50 semiconductor driver device
80 heat sink
91 board of the first layer (ground layer)
92 board of the second layer
93 board of the third layer
94 board of the fourth layer (ground layer)
102 conductor
104 conductor
Q1, Q2 switching element related to U-phase
Q3, Q4 switching element related to V-phase
Q5, Q6 switching element related to W-phase

### BEST MODE FOR CARRYING OUT THE INVENTION

In the following, the best mode for carrying out the present invention will be described in detail by referring to the accompanying drawings.

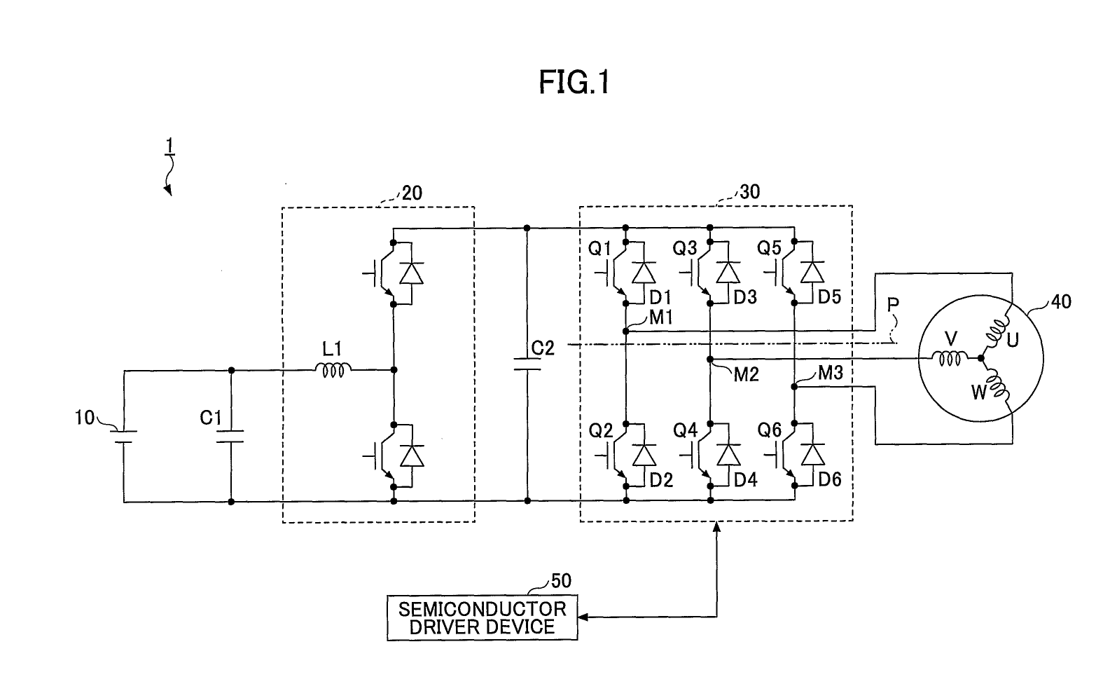

FIG. 1 is a diagram for illustrating an overview of an example of a motor drive system 1 for an electric vehicle. The motor drive system 1 is a system for driving a motor 40 for driving a vehicle using power from a battery 10. It is noted that the type of the electric vehicle or the detailed configuration of the electric vehicle may be arbitrary as long as the electric vehicle is driven with a motor using electric power. Typically, the electric vehicle includes a hybrid vehicle (HV) which uses an internal combustion engine and the motor 40 as power sources and a genuine electric vehicle which uses the motor 40 only as a power source.

The motor drive system 1 includes the battery 10, a DC-DC converter 20, an inverter 30, the motor 40 and a semiconductor driver device 50, as shown in FIG. 1.

The battery 10 is an arbitrary capacitor cell which accumulates power to output a direct-current voltage. The battery 10 may be configured as a nickel hydrogen battery, a lithium ion battery, a capacitive element such as electrical double layer capacitor, etc.

The DC-DC converter 20 is a bidirectional DC-DC converter (also referred to as variable chopper type of a step-up DC-DC converter), and is capable of converting an input voltage 14 V up to 42 V and converting an input voltage 42 V down to 14 V. A smoothing capacitor C1 is connected between an input side of an electric reactor L1 of the DC-DC converter 20 and a negative electrode line.

The inverter 30 includes arms of U-W-W phases disposed in parallel between a positive electrode line and the negative electrode line. The U-phase arm includes switching elements (IGBT in this example) Q1 and Q2 connected in series, the V-phase arm includes switching elements (IGBT in this example) Q3 and Q4 connected in series and W-phase arm includes switching elements (IGBT in this example) Q5 and Q6 connected in series. Further, diodes D1-D6 are provided between collectors and emitters of switching elements Q1-Q6, respectively. The switching elements Q1-Q6 are IGBTs (Insulated Gate Bipolar Transistor) in this example; however, the switching elements Q1-Q6 may be other transistors such as MOSFETs (metal oxide semiconductor field-effect transistor), etc.

The motor 40 is a three-phase permanent-magnetic motor and one end of each coil of the U, V and W phases is commonly connected at a midpoint therebetween. The other end of the coil of U-phase is connected to a midpoint M1 between the switching elements Q1 and Q2, the other end of the coil of V-phase is connected to a midpoint M2 between the switching elements Q3 and Q4 and the other end of the coil of W-phase is connected to a midpoint M3 between the switching elements Q5 and Q6. A smoothing capacitor C2 is connected between a collector of the switching element Q1 and the negative electrode line.

The semiconductor driver device 50 controls the inverter 30. The semiconductor driver device 50 includes a CPU, a ROM, a main memory, etc., for example, and the functions of the semiconductor driver device 50 are implemented when control programs stored in the ROM are read out from the main memory and then executed by the CPU. The control method of the inverter 30 may be arbitrary; however, in general, two switching elements Q1 and Q2 related to U-phase are turned on/off in reversed phase with respect to each other, two switching elements Q3 and Q4 related to V-phase are turned on/off in reversed phase with respect to each other and two switching elements Q5 and Q6 related to W-phase are turned on/off in reversed phase with respect to each other.

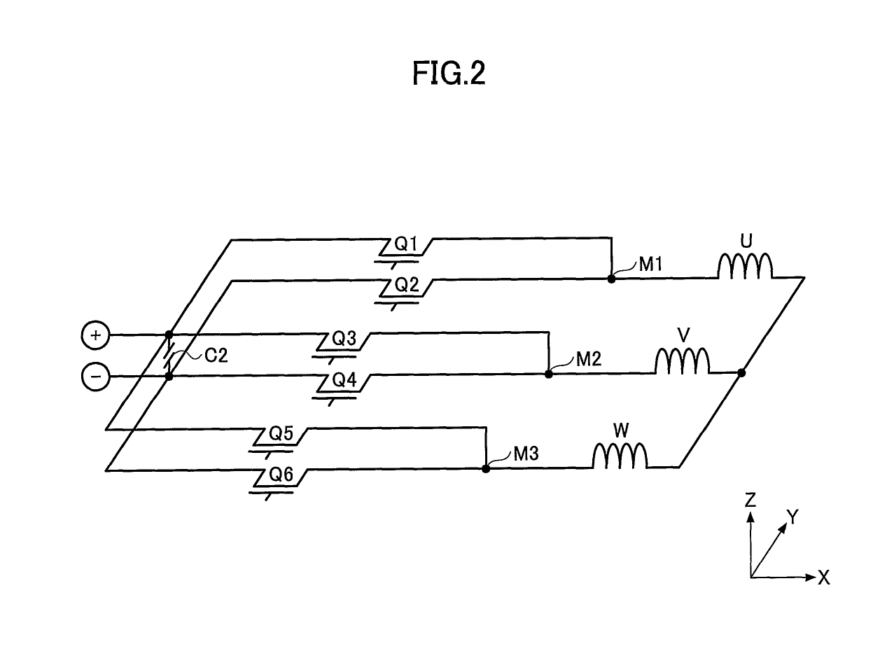

FIG. 2 is a diagram for conceptually illustrating a circuit arrangement of the inverter 30 and the motor 40 in the motor drive system 1 shown in FIG. 1 to which an embodiment of a noise reduction arrangement according to the present invention is applied.

In the present embodiment, the inverter 30 is configured in such a manner that respective current loops, which are generated when two switching elements Q1 and Q2 related to U-phase are turned on or off in reversed phase with respect to each other, are opposed to each other in a direction Z of the normal to a board; respective current loops, which are generated when two switching elements Q3 and Q4 related to V-phase are turned on or off in reversed phase with respect to each other, are opposed to each other in the direction Z of the normal to the board; and respective current loops, which are generated when two switching elements Q5 and Q6 related to W-phase are turned on or off in reversed phase with respect to each other, are opposed to each other in the direction Z of the normal to the board. In other words, the inverter 30 is disposed such that the positive electrode side and the negative electrode side are opposed to each other by folding along a line P shown in FIG. 1.

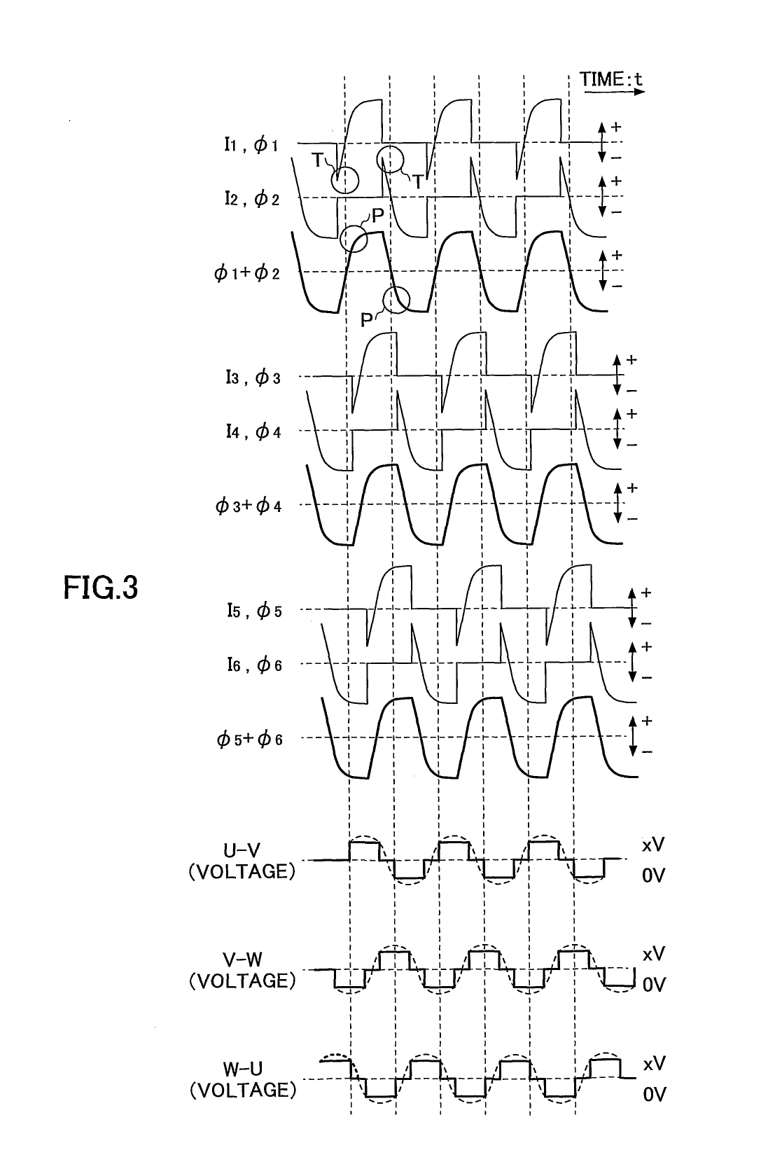

FIG. 3 is a timing chart of waveshapes of current and magnetic flux and shows an operation of the inverter 30 shown in FIG. 2.

In FIG. 3, I1 indicates a current passing through the switching element Q1 related to U-phase and I2 indicates a current passing through the switching element Q2 related to U-phase. Φ1 indicates magnetic flux through a current loop generated by the current I1. The waveshape of the magnetic flux Φ1 itself is substantially the same as that of the current I1 and thus the magnetic flux Φ1 and the current I1 are written side by side. Φ2 indicates magnetic flux through a current loop generated by the current I2. The waveshape of the magnetic flux Φ2 itself is substantially the same as that of the current I2 and thus the magnetic flux Φ2 and the current I2 are written side by side. In the present embodiment, as mentioned above, the respective current loops, which are generated when two switching elements Q1 and Q2 related to U-phase are turned on or off in reversed phase with respect to each other, are opposed to each other in a direction Z of the normal to a board surface. Thus, when viewed from the direction Z of the normal to the board surface, the current loop generated by I1 and the current loop generated by I2 are superposed, and the respective fluxes in the superposed area are superposed. Therefore, the magnetic flux Φ1+Φ2 indicates the magnetic flux in such a superposed area.

Further, in FIG. 3, I3 indicates a current passing through the switching element Q3 related to V-phase and I4 indicates a current passing through the switching element Q4 related to V-phase. Φ3 indicates magnetic flux through a current loop generated by the current I3. The waveshape of the magnetic flux Φ3 itself is substantially the same as that of the current I3 and thus the magnetic flux Φ3 and the current I3 are written side by side. Φ4 indicates magnetic flux through a current loop generated by the current I4. The waveshape of the magnetic flux Φ4 itself is substantially the same as that of the current I4 and thus the magnetic flux Φ4 and the current I4 are written side by side. In the present embodiment, as mentioned above, the respective current loops, which are generated when two switching elements Q3 and Q4 related to V-phase are turned on or off in reversed phase with respect to each other, are opposed to each other in a direction Z of the normal to a board surface. Thus, when viewed from the direction Z of the normal to a board surface, the current loop generated by I3 and the current loop generated by I4 are superposed, and the respective fluxes in the superposed area are superposed. Therefore, the magnetic flux Φ3+Φ4 indicates the magnetic flux in such a superposed area.

Further, in FIG. 3, I5 indicates a current passing through the switching element Q5 related to W-phase and I6 indicates a current passing through the switching element Q6 related to W-phase. Φ5 indicates magnetic flux through a current loop generated by the current I5. The waveshape of the magnetic flux Φ5 itself is substantially the same as that of the current I5 and thus the magnetic flux Φ5 and the current I5 are written side by side. Φ6 indicates magnetic flux through a current loop generated by the current I6. The waveshape of the magnetic flux Φ6 itself is substantially the same as that of the current I6 and thus the magnetic flux Φ6 and the current I6 are written side by side. In the present embodiment, as mentioned above, the respective current loops, which are generated when two switching elements Q5 and Q6 related to W-phase are turned on or off in reversed phase with respect to each other, are opposed to each other in a direction Z of the normal to a board surface. Thus, when viewed from the direction Z of the normal to the board surface, the current loop generated by I5 and the current loop generated by I6 are superposed, and the respective fluxes in the superposed area are superposed. Therefore, the magnetic flux Φ5+Φ6 indicates the magnetic flux in such a superposed area.

It is noted that in FIG. 3 waveshapes of voltages U-V, V-W and W-U are shown. These waveshapes themselves are the same as those in an ordinary configuration. As shown in FIG. 3, alternating voltages similar to sinusoidal curves (indicated by broken lines) are generated with combinations of rectangular waves generated from a direct-current power source (i.e., the battery 10). In this way, the motor 40 is driven for driving the vehicle.

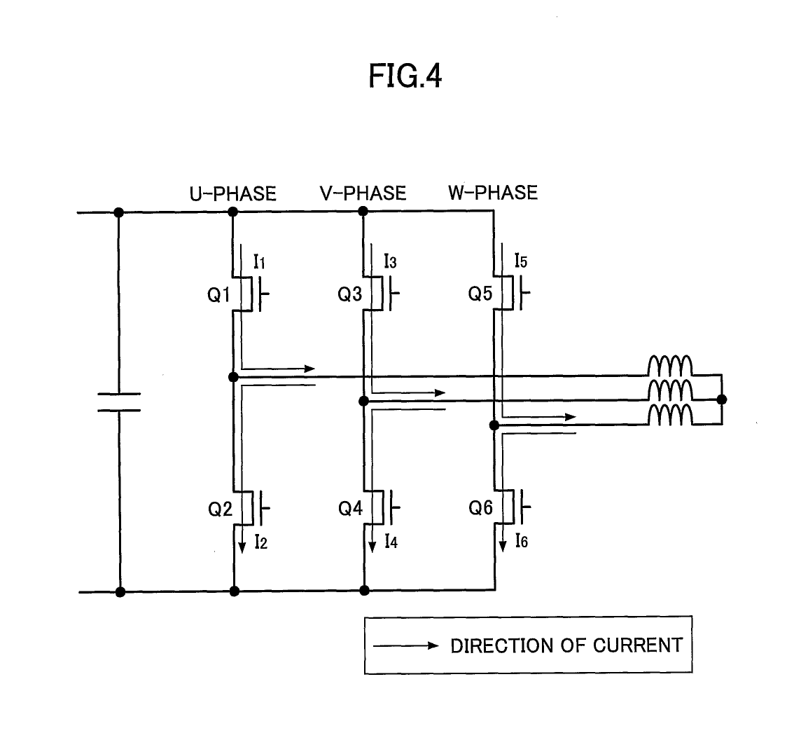

Here, in the present embodiment, the superposed waveshapes of the magnetic fluxes Φ1+Φ2, Φ3+Φ4 and Φ5+Φ6 are generated in the area in which two current loops are superposed, as mentioned above. This is in contrast to a prior art configuration with an arrangement shown in FIG. 4. In other words, in the prior art configuration shown in FIG. 4, the current loop generated by the current I1 and the current loop generated by the current I2, for example, are not opposed to each other in a direction Z of the normal to a board surface and thus the superposition of the magnetic fluxes doesn't occur. In contrast, according to the present embodiment, it becomes possible to smooth a waveshape of magnetic flux as a whole due to the superposition of the magnetic fluxes as mentioned above, as shown by the superposed waveshapes of the magnetic fluxes Φ1+Φ2, Φ3+Φ4 and Φ5+Φ6 in FIG. 3.

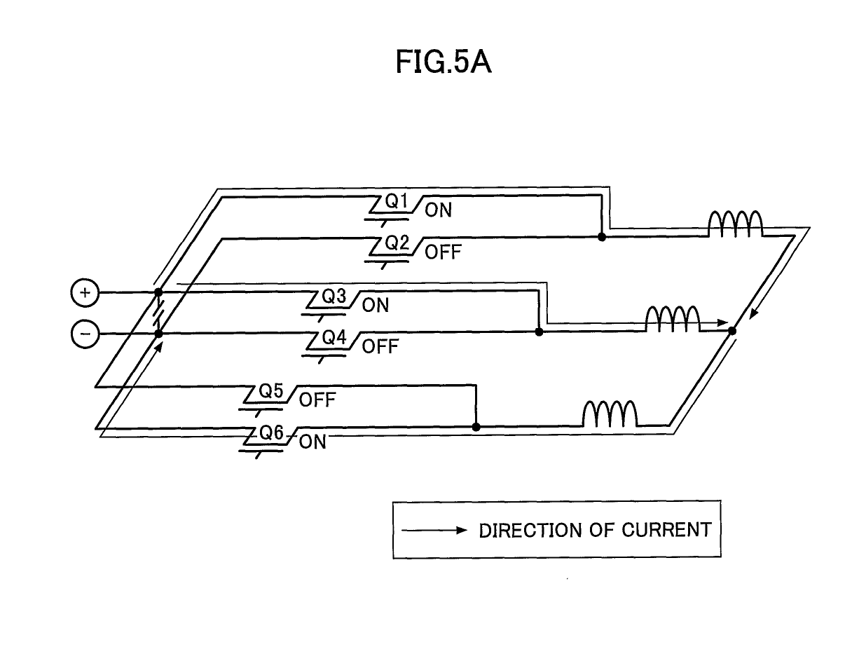

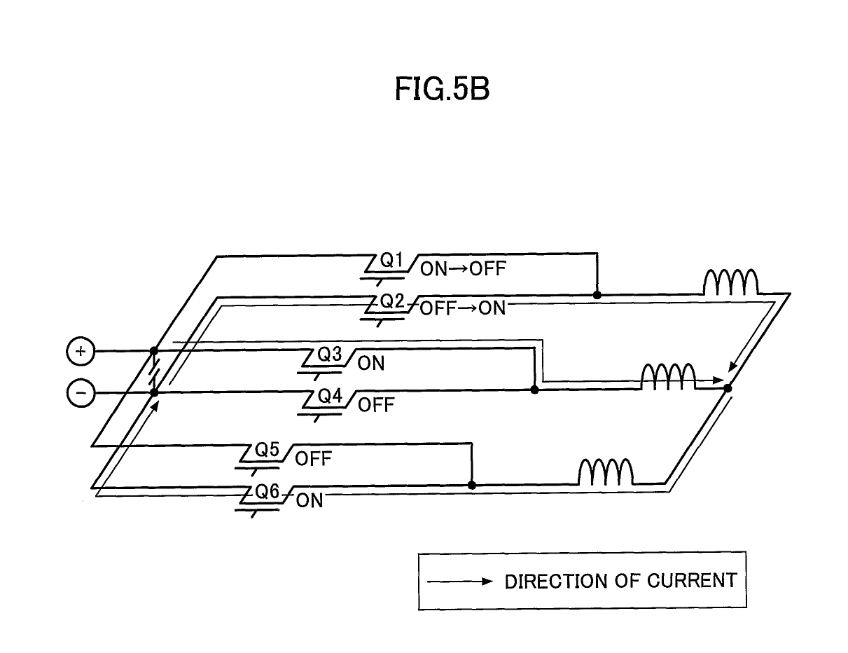

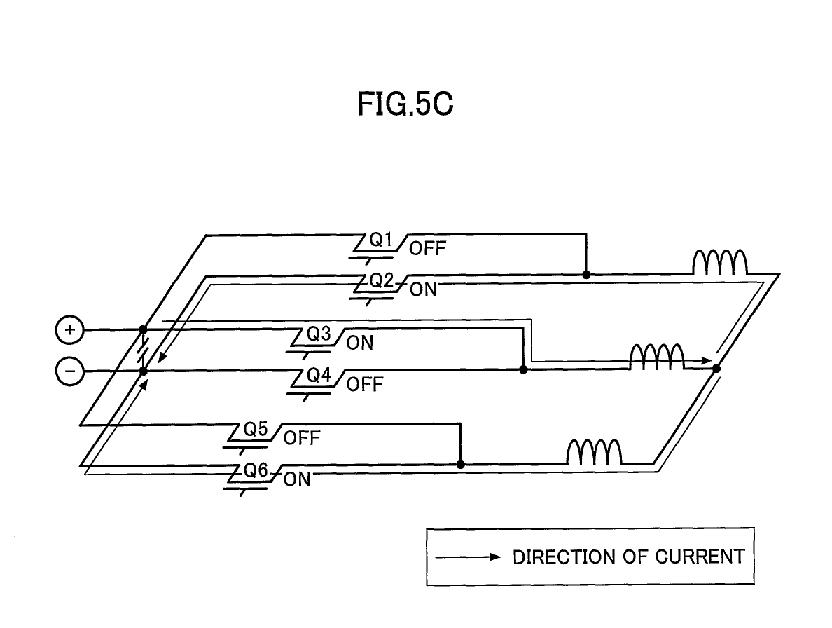

Here, when considering U-phase, for example, at first, a first state shown in FIG. 5A is assumed in which the switching elements Q1 and Q2 are in on and off states, respectively, the switching elements Q3 and Q4 are in on and off states, respectively, and switching elements Q5 and Q6 are in on and off states, respectively. In this first state, a current flows in such a manner shown by arrows in FIG. 5A. Then, a case is assumed in which the switching elements Q1 and Q2 are reversed from on and off states to off and on states, respectively. In other words, a case is assumed in which the transition from the first state to a second state occurs. When the transition to the second state is completed, a current flows in such a manner shown by arrows in FIG. 5C. However, under a transient state from the first state to the second state, as a transient phenomenon a current flow in the opposite direction due to the existence of a coil (i.e., inductance) as shown in FIG. 5B. This is shown conceptually by a portion T (right side) of the waveshape in FIG. 3. Such a transient current is also generated in a similar manner when the switching elements Q1 and Q2 are reversed from off and on states to on and off states, respectively. This is shown conceptually by a portion T (left side) of the waveshape in FIG. 3. Because of generation of such a transient current (and thus magnetic flux) the waveshape of the magnetic flux as a whole is effectively smoothed in a synergistic relationship with respect to the above-mentioned superposition of the magnetic fluxes, as shown by a portion P in FIG. 3.

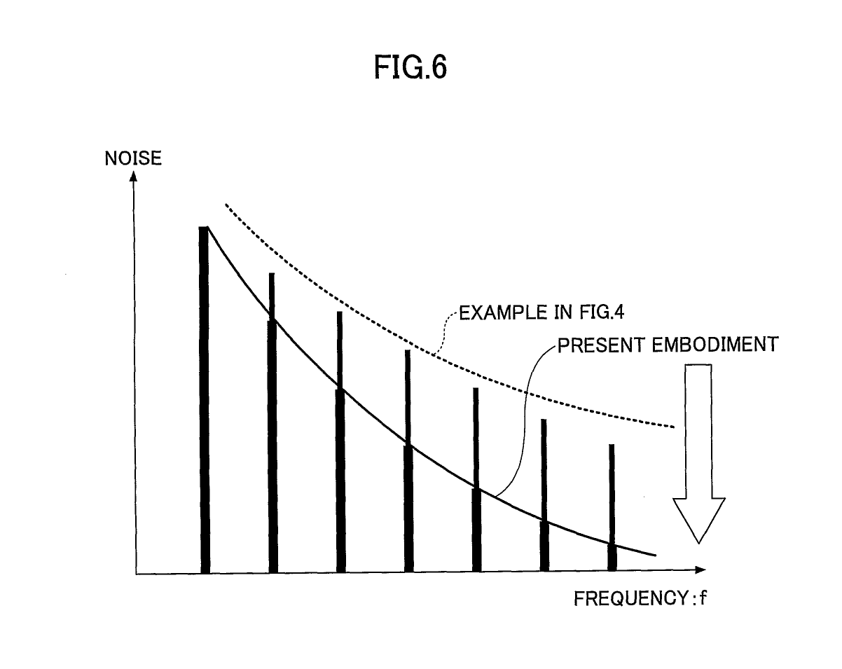

FIG. 6 shows a frequency distribution of a noise spectrum which can be obtained by FFT (fast Fourier transform), for example. In the present embodiment, since the waveshape of the magnetic flux as a whole (i.e., a variation in magnetic flux as a whole) is smoothed as mentioned above, higher harmonics of noise can be effectively reduced compared to the prior art configuration shown in FIG. 4, as conceptually shown in FIG. 6.

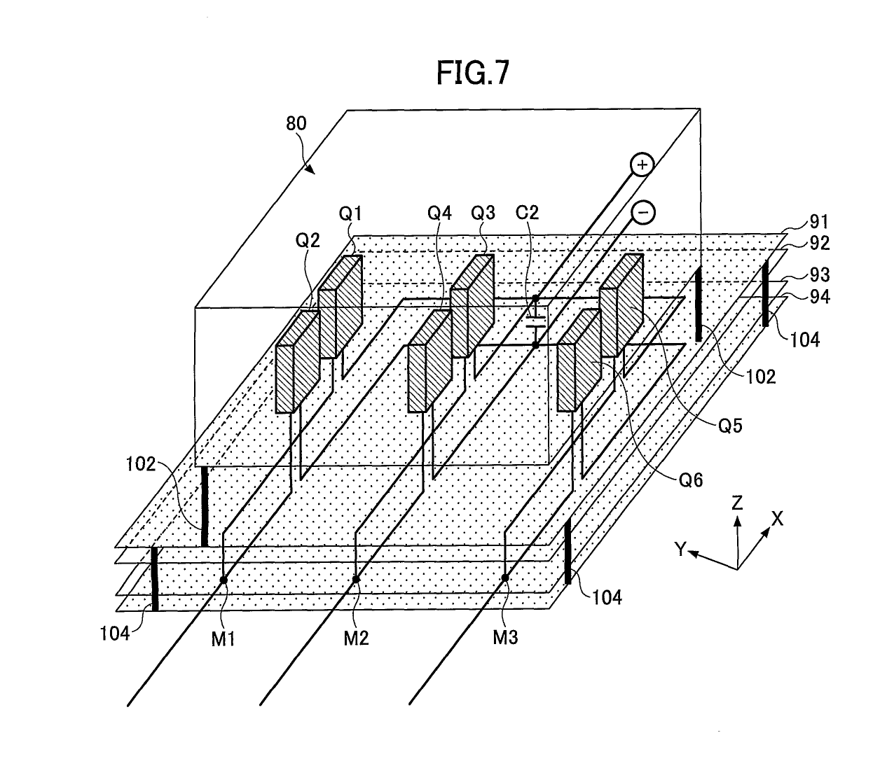

FIG. 7 is a diagram for conceptually illustrating a mounted status of the inverter shown in

FIG. 2. In the example shown in FIG. 7, four layers of boards 91, 92, 93 and 94 which are stacked in a direction Z perpendicular to the boards are used. From an upper side, the board of the first layer 91 is a ground layer. Ground potential is formed on an upper side of the board 91 by a solid pattern of copper, for example.

On an upper side of the board of the second layer 92 is formed a circuit portion which is connected to the positive electrode of the battery 10 via the switching element Q1 on the positive electrode side from a midpoint M1 between the switching elements Q1 and Q2 related to U-phase (i.e., a circuit portion on the positive electrode side in U-phase). Further, on an upper side of the board of the second layer 92 is formed a circuit portion which is connected to the positive electrode of the battery 10 via the switching element Q3 on the positive electrode side from a midpoint M2 between the switching elements Q3 and Q4 related to V-phase (i.e., a circuit portion on the positive electrode side in V-phase). Similarly, on an upper side of the board of the second layer 92 is formed a circuit portion which is connected to the positive electrode of the battery 10 via the switching element Q5 on the positive electrode side from a midpoint M3 between the switching elements Q5 and Q6 related to W-phase (i.e., a circuit portion on the positive electrode side in W-phase).

On an upper side of the board of the third layer 93 is formed a circuit portion which is connected to the negative electrode of the battery 10 via the switching element Q2 on the negative electrode side from the midpoint M1 between the switching elements Q1 and Q2 related to U-phase (i.e., a circuit portion on the negative electrode side in U-phase). Further, on an upper side of the board of the third layer 93 is formed a circuit portion which is connected to the negative electrode of the battery 10 via the switching element Q4 on the negative electrode side from the midpoint M2 between the switching elements Q3 and Q4 related to V-phase (i.e., a circuit portion on the negative electrode side in V-phase). Similarly, on an upper side of the board of the second layer 93 is formed a circuit portion which is connected to the negative electrode of the battery 10 via the switching element Q6 on the negative electrode side from the midpoint M3 between the switching elements Q5 and Q6 related to W-phase (i.e., a circuit portion on the negative electrode side in W-phase).

The fourth layer board 94 is a ground layer. Ground potential is formed on an upper side of the board 94 by a solid pattern of copper, for example.

In this way, in the example shown in FIG. 7, the boards 92 and 93 on which U, V and W-phases patterns are formed are sandwiched in a direction Z perpendicular to the board surface between the respective boards 91 and 94 which form ground layers. As a result of this, it becomes possible to minimize a common mode noise loop and prevent leakage of the common mode noise.

The switching elements Q1-Q6 are housed in a heat sink 80 which is provided above the board of the first layer 91 in a direction Z perpendicular to the board surface. The switching elements Q1-Q6 are connected to the corresponding circuit portions on the boards 92 and 93 via through holes formed in the direction Z perpendicular to the board surfaces. It is noted that as a matter of fact the through holes from the circuit portions on the negative electrode side in U, V and W-phases are offset from the circuit portions on the positive electrode side in U, V and W-phases (in a Y-direction in FIG. 7) so as not to establish electrical connections therebetween. Further, the solid pattern of copper is formed on the board of the first layer 91 by masking the areas in which the through holes are formed.

The heat sink 80 is formed of an electrically conductive material (for example, an aluminum block). The heat sink 80 may include concave portions for receiving the switching elements Q1-Q6 in such a manner that concave portions are in contact with the corresponding switching elements Q1-Q6. The heat sink 80 may have a fin formed thereon so as to enhance heat radiation characteristics. In this way, the heat sink 80 has not only a heat sink function but also a shielding function for shielding radiation noise from the switching elements Q1-Q6.

Metal portions of the heat sink 80 such as a conductor 102 are connected to the ground layer of the board of the first layer 91. Further, the ground layer of the board of the first layer 91 is connected to the ground layer of the board of the fourth layer 94 via through holes or via conductors 104 which are provided between the edge faces of the boards 91 and 94. As a result of this, the electrical connections between the respective ground layers and the shielding portion of the heat sink are established and thus common mode noise can be shielded effectively. It is noted that from a similar point of view the motor 40 may be surrounded with a shielding element which is electrically connected to the respective ground layers of the boards 91 and 94.

The present invention is disclosed with reference to the preferred embodiments. However, it should be understood that the present invention is not limited to the above-described embodiments, and variations and modifications may be made without departing from the scope of the present invention.

For example, in the above-described embodiments, the circuit portion on the positive electrode side related to U, V and W phases and the circuit portion on the negative electrode side related to U, V and W phases are formed on the board 92 and 93, respectively. However, the present invention is not limited to this, and thus the mounting manner may be arbitrary as long as the superposed area of the loops such as shown in FIG. 2 is formed. For example, the circuit portion on the positive electrode side related to U, V and W phases and the circuit portion on the negative electrode side related to U, V and W phases may be formed on front and back faces of one of the boards 92 and 93. In this case, the other of the boards 92 and 93 can be omitted.

Further, in the above-described embodiments, the heat sink 80 is provided on the side of the board 91; however, the heat sink 80 may be provided on the side of the board 92. The heat sink 80 may be disposed in a upside down manner with respect to the example shown in FIG. 7.

The present application is based on Japanese Priority Application No. 2009-089599, filed on Apr. 1, 2009, the entire contents of which are hereby incorporated by reference.

1. A noise reduction arrangement applied to a three-phase brushless motor, wherein
respective current loops, which are generated when two switching elements related to U-phase are turned on or off in reversed phase with respect to each other, are opposed to each other in a direction of the normal to a board,
respective current loops, which are generated when two switching elements related to V-phase are turned on or off in reversed phase with respect to each other, are opposed to each other in a direction of the normal to a board, and
respective current loops, which are generated when two switching elements related to W-phase are turned on or off in reversed phase with respect to each other, are opposed to each other in a direction of the normal to a board.

2. A noise reduction arrangement applied to a three-phase brushless motor, wherein
a circuit portion from a midpoint between two switching elements related to U-phase to a point connected to a positive electrode side of a power source via one of the switching elements related to U-phase which is located on the positive electrode side and a circuit portion from said midpoint to a negative electrode side of the power source via the other of the switching elements related to U-phase which is located on the negative electrode side are formed on multilayered first board and second boards, respectively,
a circuit portion from a midpoint between two switching elements related to V-phase to a point connected to a positive electrode side of a power source via one of the switching elements related to V-phase which is located on the positive electrode side and a circuit portion from said midpoint to a negative electrode side of the power source via the other of the switching elements related to V-phase which is located on the negative electrode side are formed on the multilayered first board and second boards, respectively, and
a circuit portion from a midpoint between two switching elements related to W-phase to a point connected to a positive electrode side of a power source via one of the switching elements related to W-phase which is located on the positive electrode side and a circuit portion from said midpoint to a negative electrode side of the power source via the other of the switching elements related to W-phase which is located on the negative electrode side are formed on the multilayered first board and second boards, respectively.

3. A noise reduction arrangement applied to a three-phase brushless motor, wherein
a circuit portion from a midpoint between two switching elements related to U-phase to a point connected to a positive electrode side of a power source via one of the switching elements related to U-phase which is located on the positive electrode side, and a circuit portion from said midpoint to a negative electrode side of the power source via the other of the switching elements related to U-phase which is located on the negative electrode side are formed on first and second surfaces of a board, respectively,
a circuit portion from a midpoint between two switching elements related to V-phase to a point connected to a positive electrode side of a power source via one of the switching elements related to V-phase which is located on the positive electrode side, and a circuit portion from said midpoint to a negative electrode side of the power source via the other of the switching elements related to V-phase which is located on the negative electrode side are formed on the first and second surfaces of the board, respectively, and
a circuit portion from a midpoint between two switching elements related to W-phase to a point connected to a positive electrode side of a power source via one of the switching elements related to W-phase which is located on the positive electrode side and a circuit portion from said midpoint to a negative electrode side of the power source via the other of the switching elements related to W-phase which is located on the negative electrode side are formed on the first and second surfaces of the board, respectively.

4. The noise reduction arrangement as claimed in claim 2, wherein the first and second boards are sandwiched between boards forming ground layers in a direction perpendicular to the surfaces of the first and second boards.

5. The noise reduction arrangement as claimed in claim 3, wherein the board is sandwiched between boards forming ground layers in a direction perpendicular to the surfaces of the board.

6. The noise reduction arrangement as claimed in claim 2, wherein the respective switching elements related to U, V and W phases are housed in a heat sink which is provided above or below the first or the second board in a direction perpendicular to said board, and said heat sink also functions as a shield arrangement for shielding a noise radiated from the respective switching elements.

7. The noise reduction arrangement as claimed in claim 3, wherein the respective switching elements related to U, V and W phases are housed in a heat sink which is provided above or below the board in a direction perpendicular to said board, and said heat sink also functions as a shield arrangement for shielding a noise radiated from the respective switching elements.

8. The noise reduction arrangement as claimed in claim 6, wherein the first and second boards on which U/V/W patterns are formed are sandwiched between boards forming ground layers in a direction perpendicular to the surfaces of the first and second boards, and
the respective boards forming ground layers and the heat sink are electrically connected to each other.

9. The noise reduction arrangement as claimed in claim 7, wherein the board on which U/V/W patterns are formed is sandwiched between boards forming ground layers in a direction perpendicular to the surfaces of the board, and .
the respective boards forming ground layers and the heat sink are electrically connected to each other.

10. A motor drive system for a vehicle, comprising: an inverter including the noise reduction arrangement as claimed in claim 1, and the three-phase brushless motor connected to the inverter.

11. A motor drive system for a vehicle, comprising: an inverter including the noise reduction arrangement as claimed in claim 2, and the three-phase brushless motor connected to the inverter.

12. A motor drive system for a vehicle, comprising: an inverter including the noise reduction arrangement as claimed in claim 3, and the three-phase brushless motor connected to the inverter.
